(19) United States
(12) Patent Application Publication
(10) Pub. No.: US 2006/0238059 A1
(43) Pub. Date: Oct. 26, 2006

(54) Synchronous motor

(76) Inventor: Fumito Komatsu, Shiojiri-shi (JP)

Correspondence Address: BIRCH STEWART KOLASCH & BIRCH, PO BOX 747, FALLS CHURCH, VA, 22040-0747, US

(21) Appl. No.: 10/568,314

(22) PCT Filed: Aug. 19, 2003
(86) PCT No.: PCT/JP04/07501

§ 371 Date: Feb. 16, 2006

(30) Foreign Application Priority Data
Aug. 19, 2003 (JP) 2003-295629

(51) Int. Cl. H02K 19/00; H02K 1/00; H02K 1/12

(52) U.S. Cl. 310/162; 29/596; 310/216; 310/254; 310/318

(57) ABSTRACT

There is provided a synchronous motor where the winding density of coiled wires wound around a stator core via a bobbin is improved.

A stator core 26 is assembled so as to be dividable on both sides in the axial direction of a bobbin 29 around which a coiled wire 28 is wound.

### TECHNICAL FIELD

The present invention relates to a synchronous motor.

### BACKGROUND ART

In recent years, devices such as OA appliances have been equipped with DC or AC fan motors for cooling, with two-pole and four-pole AC fan motors being preferably used in appliances where a high rotational speed is required.

One construction of an AC fan motor is a synchronous motor that includes diodes, brushes, and a commutator in a rectifier circuit connected to a coil. This motor is started as a DC motor by rectifying an AC current supplied from an AC power supply to energize a rotor and thereby cause the rotor to rotate. The rotation of the rotor is raised to a state close to synchronous rotation, and at this point, the commutator is mechanically disconnected from the rectifier circuit to switch to synchronous driving of the motor by the AC power supply (see Japanese Laid-Open Patent Publication No. H09-84316 and Japanese Patent Application No. H09-135559).

The following synchronous motor has also been proposed (see Japanese Laid-Open Patent Publication No. 2000-125580 and Japanese Laid-Open Patent Publication No. 2000-166287). The supplying of current is controlled by a rotation control unit (a microcomputer or the like) to switch the current direction of a rectified current that flows to an A coil and a B coil of a starter circuit to start the motor. Alternatively, switching control is carried out in a range where a rectified current that flows alternately through a coil of a starter circuit is inverted to suppress the input on the inverted side with respect to the non-inverted side and thereby start the motor. When the rotational speed of the rotor which is detected by an optical sensor approaches the synchronous rotation speed, a switch for switching the driving switches to a synchronous driving circuit to carry out a transition to synchronous driving. In such synchronous motors, a bobbin made of insulating resin is fitted into a channel portion of a stator core (a laminated core) and wire is wound around the bobbin as a coil. This wire is wound around the bobbin using an automated machine or the like with a predetermined number of turns in a predetermined winding direction in accordance with the direction of rotation of the motor.

### DISCLOSURE OF THE INVENTION

With the synchronous motors described above, there is the problem that the series of operations that mounts the bobbin on a small stator core and winds the wire around the bobbin is difficult to automate, and since there are a large number of assembly processes, productivity of the motor is low.

Also, when winding the wire around the bobbin, due to bending, flexing in the external form, and the like of the bobbin, it has been difficult to wind the coil with neatly aligned turns. As a result, the winding density of the coil is reduced, which makes it difficult to raise the efficiency of the motor.

Also, if a supplementary core is provided in the circumferential direction on the stator core to stabilize the direction in which the rotor starts to rotate, the space for installing the bobbin is reduced, resulting in a smaller space in which the wire can be wound.

In addition, since it is necessary to provide wires that externally connect the coil inside the narrow space surrounded by the rotor, it is difficult to lay out such external connecting wires without interfering with the rotor.

It is a first object of the present invention to improve the winding density of a coil wound around a stator core via a bobbin and to improve the mass productivity of a motor by simplifying the assembly procedure, it is a second object to stabilize the starting direction of rotation of a rotor, and it is a third object to provide a synchronous motor that can make effective use of limited space by shortening the wire lengths of wires for externally connecting a coil.

To achieve the stated object, the present invention has the following constructions.

A first construction is a synchronous motor including a rotor that is supported inside a housing so as to be rotatable about an output shaft and a stator disposed in a void surrounded by the rotor, wherein a stator core is assembled so as to be dividable on both sides in an axial direction of a bobbin around which a coiled wire is wound.

Magnetic pole acting surface portions of the stator core that oppose the rotor may have different shapes on both sides of a central axis in a long-side direction of the stator core so as to be magnetically asymmetrical about the central axis.

The coiled wire may be wound into a coil in advance using a winding jig and fitted into a channel portion of the bobbin.

The coiled wire may be wound into a coil in advance and fitted into a channel portion of the bobbin, the channel portion being U-shaped in cross section by having an erected wall that surrounds a cylindrical winding center portion integrally formed via a bridging portion, and divided parts of the stator core may be inserted into the winding center portion from both sides thereof in the axial direction and fitted together with front end portions thereof abutting.

The winding center portion may be formed so as to protrude further outward than the erected wall, and a connecting substrate, on which a wiring pattern for connecting terminals of the coiled wire together is formed, may be covered on both sides by insulating films and fitted onto the winding center portion so as to be sandwiched by the stator core and the erected wall.

A second construction is a synchronous motor including a rotor that is supported inside a housing so as to be rotatable about an output shaft and a stator disposed in a void surrounded by the rotor, wherein a stator core is assembled so as to be dividable on both sides in an axial direction of bobbins around which coiled wires are wound and a connecting substrate for connecting the coiled wires together is disposed at facing surfaces of the bobbins.

Magnetic pole acting surface portions of the stator core that oppose the rotor may have different shapes on both sides of a central axis in a long-side direction of the stator core so as to be magnetically asymmetrical about the central axis.

The coiled wires may be wound into coils in advance using a winding jig and fitted into channel portions of the bobbins.

The synchronous motor may further include a linking plate that links and fixes together divided parts of the stator core that have been assembled from both sides through centers of the bobbins.

Also, an inner circumferential surface of a rotor magnet that opposes a stator magnet may be sinusoidally magnetized and a magnetic pole detection surface may be trapezoidally magnetized.

By using the synchronous motor of the first construction, since the stator core is assembled so as to be dividable on both sides in an axial direction of a bobbin around which motor coils are wound, it is possible to attach the stator core without dividing the bobbin inside the limited space surrounded by the rotor. Accordingly, it is possible to provide sufficient space to wind the coiled wire.

Since the magnetic pole acting surfaces of the stator core that oppose the rotor may have different shapes on both sides of a central axis in a long-side direction of the stator core so as to be magnetically asymmetrical about the central axis, it is possible to stabilize the direction of rotation of the rotor during starting.

Since the coiled wire may be wound into a coil in advance using a winding jig and fitted into a channel portion of the bobbin, it is possible to form the coiled wires by neatly winding the wire without being affected by bending and the like of the bobbin. Accordingly, the winding density can be raised and therefore the efficiency of the motor can be improved.

Since the coiled wire may be wound into a coil in advance and fitted into a channel portion of the bobbin, the channel portion being U-shaped in cross section by having an erected wall that surrounds a winding center portion integrally formed via a bridging portion, the assembly process of the motor can be simplified and by further automating the assembling of the motor, the productivity can be improved.

Since a connecting substrate, on which a wiring pattern for connecting terminals of the coiled wire together is formed, is fitted onto the winding center portion, a space inside the housing can be used to connect wiring via the connecting substrate and the wire lengths of the coil external connecting wires can be shortened, thereby avoiding interference with the rotor.

Also, by using the synchronous motor of the second construction, since the stator core is assembled so as to be dividable on both sides in an axial direction of bobbins around which coiled wires are wound, the output shaft can pass through the stator core and transmit the driving on one or both sides, making the motor very convenient. Also, by disposing a connecting substrate for connecting the coiled wires together at facing surfaces of the bobbins, it is possible to further shorten the wire lengths of the coil connecting wires, which makes it possible to reduce the size of the motor.

Also, since the divided bobbins can be assembled with the connecting substrate and the stator core in a state where the coiled wires that have already been wound into coils have been fitted into the channel portions and components with the same shapes on the left and right sides are used, it is possible to improve productivity and to simplify the assembly process of the motor. For this reason, by further automating the assembling of the motor, it is possible to improve the productivity.

### BRIEF DESCRIPTION OF THE DRAWINGS

FIG. 1A is a cross-sectional view in a long-side direction of a stator core of a two-pole synchronous motor according to a first construction and FIG. 1B is a cross-sectional view when looking from inside an upper housing;

FIG. 2A is a cross-sectional view of the two-pole synchronous motor looking from a connecting substrate side, FIG. 2B is a plan view, FIG. 2C is a diagram useful in explaining the connecting substrate, and FIG. 2D is a partial cross-sectional view showing a state where a stator frame and a lower housing are assembled;

FIG. 3A is a perspective view of the connecting substrate and FIG. 3A is a perspective view of insulating films;

FIG. 4 is a perspective view of a bobbin and a coil;

FIG. 5 is a perspective view of a stator core;

FIG. 6A is a perspective view of a wire leading portion, FIG. 6B is a perspective view of a sensor substrate, FIG. 6C is a perspective view of a stator frame, and FIG. 6D is a perspective view of a lower housing;

FIG. 7 is a view from below showing a state where the stator frame is assembled on the lower housing;

FIG. 8 is a perspective view of a state where the stator core is assembled on the bobbin;

FIG. 9 is a perspective view of a state where the stator is assembled on the stator frame;

FIG. 10 is an exploded perspective view of a two-pole synchronous motor according to the first construction;

FIG. 11 is an exploded perspective view showing the assembled construction of the upper housing and the lower housing;

FIG. 12 is a diagram useful in explaining a driving circuit of the two-pole synchronous motor;

FIG. 13A is a cross-sectional view in a long-side direction of a stator core of a two-pole synchronous motor according to a second construction, FIG. 13B is an internal view, FIG. 13C is a view of a lower housing from below, FIG. 13D is a diagram useful in explaining a connecting substrate, and FIG. 13E is a partial cross-sectional view showing a state where a sensor substrate is assembled on the lower housing;

FIG. 14A is a cross-sectional view in a short-side direction of the stator core of a two-pole synchronous motor and FIG. 14B is a view from below;

FIG. 15 is a graph showing the magnetizing waveform of a permanent magnet;

FIGS. 16A to 16C are exploded perspective views of a stator and a sensor substrate that are assembled on a lower housing;

FIG. 17 is an exploded perspective view showing the assembled construction of a lower housing and an upper housing; and

FIG. 18 is an exploded perspective view of a two-pole synchronous motor according to the second construction.

### BEST MODE FOR CARRYING OUT THE INVENTION

Preferred embodiments of the present invention will now be described in detail below with reference to the attached drawings.

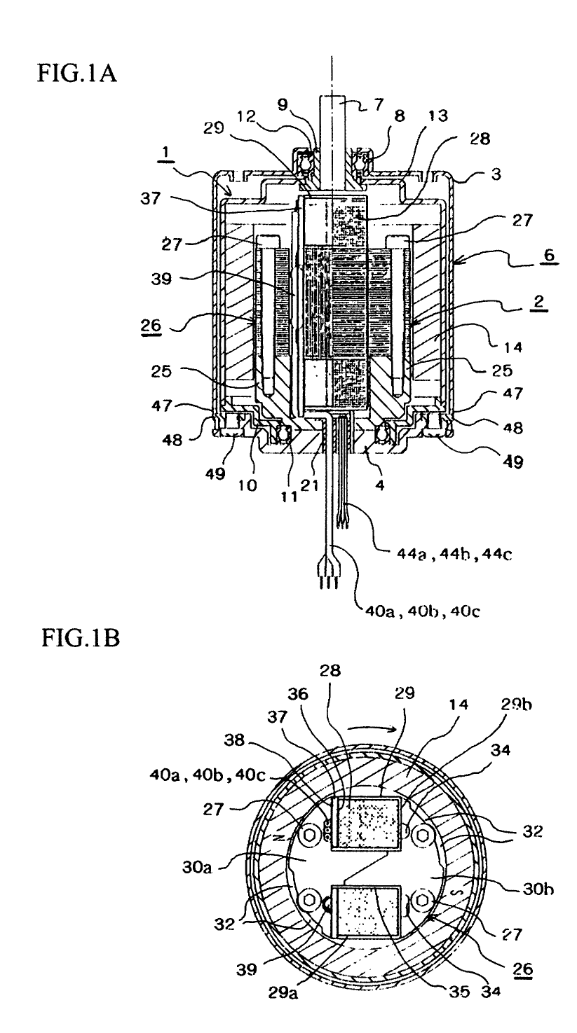

A two-pole synchronous motor will now be described as one example of an outer rotor-type synchronous motor. First, the entire construction of the two-pole synchronous motor according to a first construction will be described with reference to FIGS. 1 to 9.

In FIG. 1A, a rotor 1 and a stator 2 are housed inside a housing 6 formed by placing an upper housing 3 and a lower housing 4 on top of one another and screwing together the housings 3 and 4 using fastening screws 49. An output shaft 7 is fitted into the upper housing 3. A boss portion 9 of the output shaft 7 is rotatably supported by an upper bearing 8 fitted into the upper housing 3.

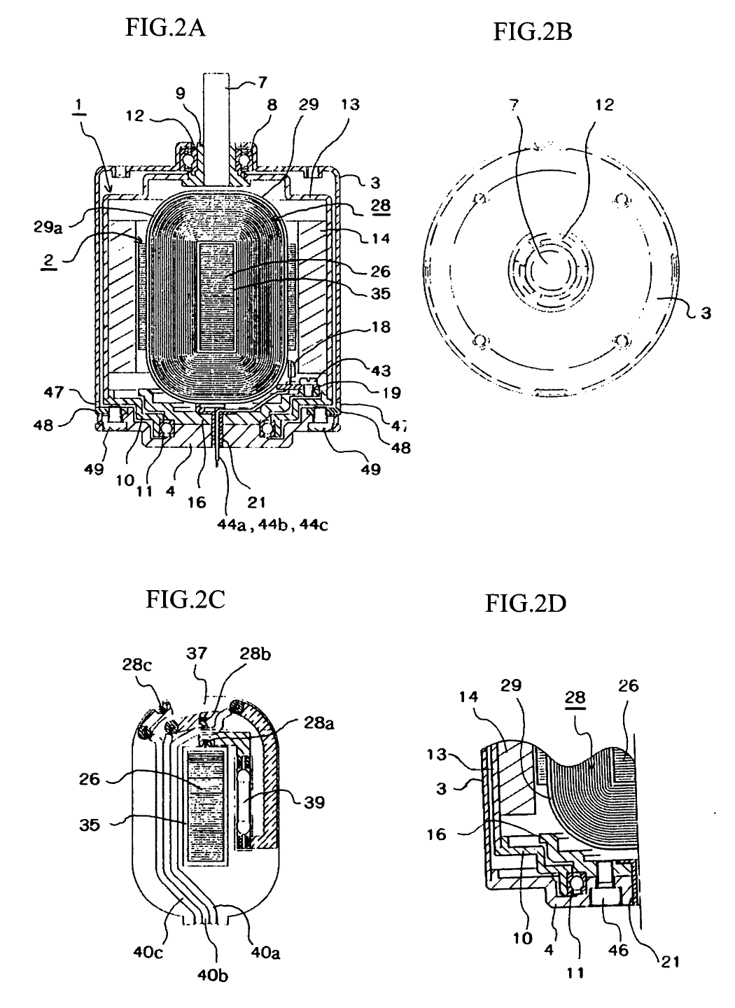

A rotor bearing member 10 is integrally fitted into the rotor 1 and the rotor bearing member 10 is rotatably supported by a lower bearing 11 fitted into the lower housing 4. To prevent disorder in the magnetic field formed by the stator coil, a non-magnetic material, such as stainless steel or an aluminum alloy, is favorably used for the upper bearing 8 and the lower bearing 11. Also, by disposing a preloaded spring 12 (see FIG. 2B) between the upper housing 3 and the upper end of the upper bearing 8 in the axial direction, the upper bearing 8 is energized downward in the axial direction to prevent the rotor 1 from rising.

The construction of the rotor 1 is as follows. As shown in FIGS. 1A and 2A, the boss portion 9 is crimped to a rotor case 13 so that the rotor case 13 is integrally linked via the boss portion 9 to the output shaft 7. The rotor case 13 is formed in a cup shape that is open at a lower end thereof, and a cylindrical permanent magnet 14 is attached to an inner circumferential surface thereof. The permanent magnet 14 is magnetized so as to have two poles that are alternately north and south approximately 180° apart in the circumferential direction. The permanent magnet 14 can be manufactured cheaply with ferrite, a rubber magnet, a plastic magnet, samarium cobalt, a rare earth magnet, neodymium-iron-boron or the like as a raw material. The rotor 1 is constructed so as to start rotating about the output shaft 7 due to repulsion from a magnetic pole formed at the stator 2 by a passing current.

In FIGS. 1A and 2A, the stator 2 is provided in the empty space surrounded by the rotor case 13. A stator frame 16 is integrally supported on the lower housing 4 by fastening screws 49 (see FIG. 2D). In FIG. 2A, a sensor substrate 19 including a Hall element 18 that detects the rotational speed and pole positions of the rotor 1 is fixed to the stator frame 16 by the fastening screws 43. The Hall element 18 detects the rotational speed and magnetic pole positions of the rotor 1 and generates pulses corresponding to the rotational speed, with a rotation circuit control unit (a microcomputer or the like) described later carrying out switching control in a starter circuit at predetermined timing in accordance with the magnetic pole positions. It should be noted that in place of the Hall element 18, it is possible to use a light-transmitting or light-reflecting optical sensor, a magnetic sensor that uses a magnetic resistance element, a coil, or the like, or a variety of sensors that use a method based on high-frequency induction or a method based on changes in capacitance.

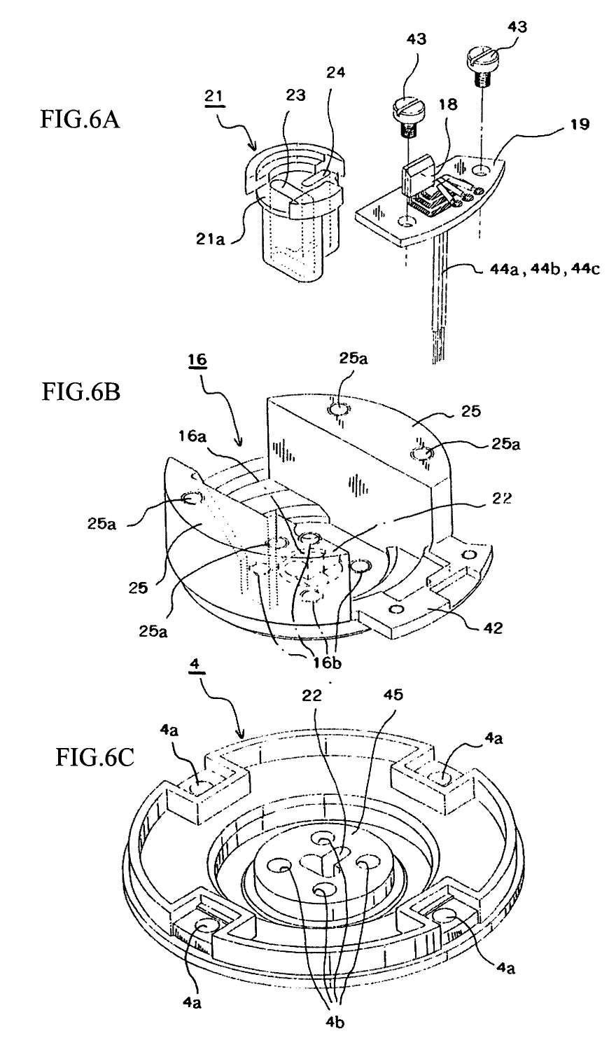

The construction of the stator 2 is as follows. In FIGS. 6A to 6C, a wire leading portion 21 that leads external connecting wires out of the housing 6 is fitted into a center portion of the stator frame 16 and the lower housing 4. The wire leading portion 21 is fitted into a fitting hole 22 provided in communication with a stator fixing portion 45 in the center portion of the stator frame 16 and the lower housing 4. An engaging portion 21a of the wire leading portion 21 that extends outward in a flange shape is fitted into and engages a concave portion 16a formed in a base portion of the stator frame 16 and thereby prevents the wire leading portion 21 from falling out of the frame. A wire leading hole (through-hole) 23 that leads wires that connect the stator coil and a sensor wire leading hole (through-hole) 24 that leads wires that connect the sensor substrate 19 that detects the rotational position of the rotor 1 are respectively provided on the wire leading portion 21. The wires led out from the wire leading hole 23 and the sensor wire leading hole 24 are electrically connected to a driving circuit control unit that constructs the starter circuit and synchronous driving circuit described later.

In FIG. 6B, a stator mounting portion 25 is provided on the stator frame 16 and a stator core 26 is mounted on the stator mounting portion 25. In FIG. 1A, the stator core 26 is fixed to the stator mounting portion 25 by fixing bolts 27. A laminated core with two slots is used as the stator core 26, and as one example a laminated core composed of silicon steel plate is favorably used. In FIG. 1B, the stator core 26 is assembled so as to be dividable on both sides in the axial direction of the bobbin 29 around which coiled wire 28 is wound.

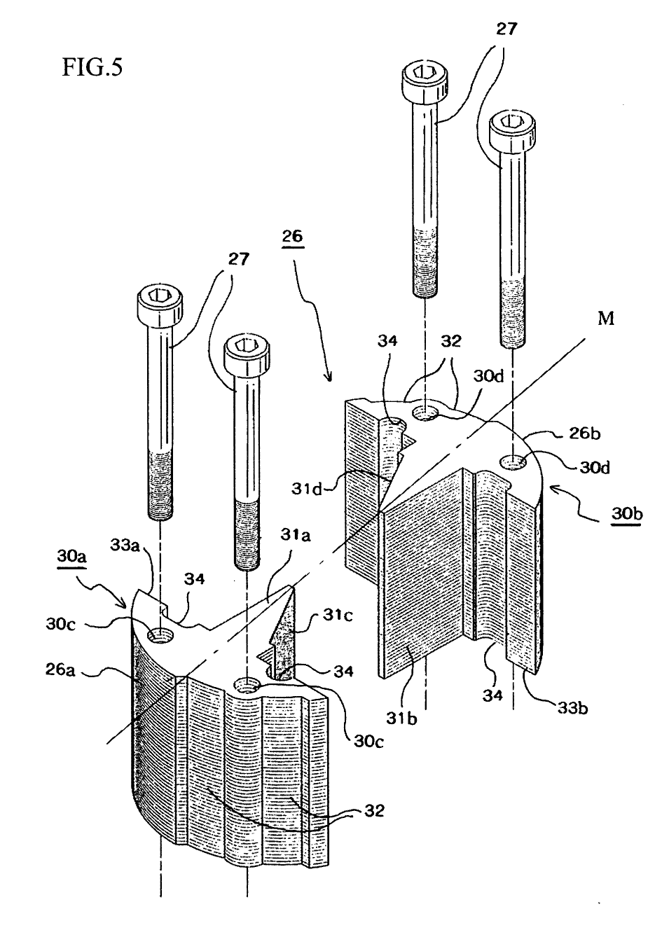

In FIG. 5, magnetic pole acting surface portions 26a, 26b of the stator core 26 that oppose the permanent magnet 14 have shapes that differ on both sides of a central axis M in the long-side direction of the stator core 26 so as to be magnetically asymmetrical about the central axis M. By doing so, by passing a current through the coiled wire 28 during starting, repulsion and attraction between the magnetic poles produced on the magnetic pole cores 30a, 30b and the rotor magnetic poles (the magnetic poles of the permanent magnet 14) stabilize the direction in which the rotor 1 starts to rotate. In this way, since the magnetic pole acting surface portions 26a, 26b that protrude outward on both sides in the circumferential direction of the magnetic pole cores 30a, 30b have different shapes on both sides of the central axis M in the long-side direction of the stator core 26 so as to be magnetically asymmetrical about the central axis M, it is possible to eliminate deadpoints for rotation during starting, so that the rotor 1 rotates in a predetermined direction (clockwise rotation in FIG. 1B for the present embodiment) and the starting rotation direction can be stabilized.

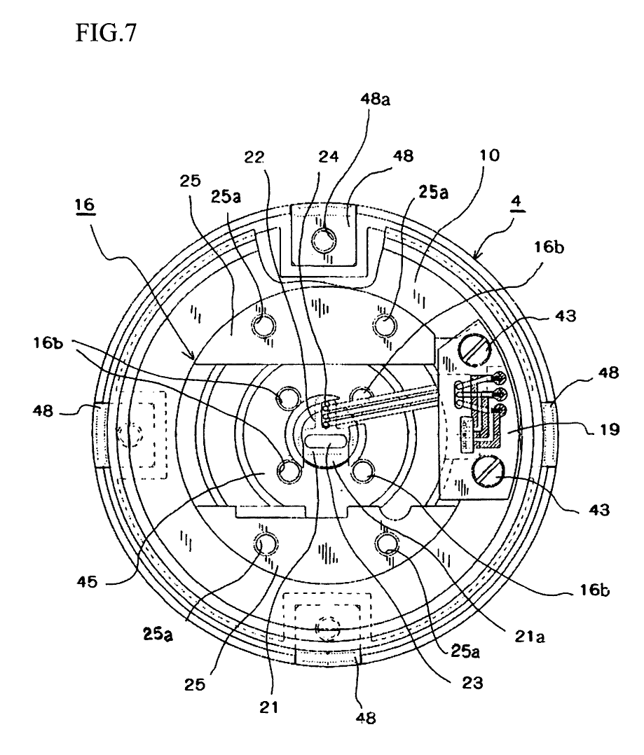

In FIG. 5, the stator core 26 is constructed so as to be dividable into a magnetic pole fragment 30a and a magnetic pole fragment 30b. Although the magnetic pole fragments 30a, 30b can have freely chosen shapes, in view of the ease of manufacturing, shapes that have point symmetry about the center of rotation of the rotor 1 are preferable. The magnetic pole fragments 30a, 30b are fitted together by placing taper portions 31c, 31d, which are formed on side surfaces of insertion portions 31a, 31b to be inserted from both sides in the axial direction of the bobbin 29, in sliding contact, inserting into an axis hole of the bobbin 29, and causing front end portions thereof to abut one another. Concave portions 32 are respectively provided on parts of the magnetic pole acting surface portions 26a, 26b to form gaps (voids) where the distance between the permanent magnet 14 on the rotor and the magnetic pole portions is increased. The concave portions 32 are formed at positions (positions that are 180° apart) that have point symmetry about the center of rotation of the rotor 1. Due to the concave portions 32, the magnetic flux that acts from the magnetic pole acting surface portions 26a, 26b is unbalanced on the left-right sides of the central axis M and is biased in one direction, that is, the magnetic flux acts on the magnetic pole acting surface portions 26a, 26b so as to be biased in the clockwise direction where the magnetic resistance is low (where the gaps are smaller). Concave portions 34 are also formed at two positions on the respective contact surface portions 33a, 33b of the magnetic pole fragments 30a, 30b that contact the bobbin 29. The concave portions 34 formed in the contact surface portions 33a, 33b are formed at positions (positions that are 180° apart) that have point symmetry about the center of rotation of the rotor 1. The concave portions 34 are used as a channel for leading external connecting wires to a connecting substrate 37 described later and a gap in which a thermal fuse 29 can be installed (see FIG. 1A). Through-holes 30c, 30d are bored into the magnetic pole fragments 30a, 30b with the fixing bolts 27 being passed therethrough and fixed. Front ends of the fixing bolts 27 are screwed into and fixed to screw holes 25a formed in the stator mounting portion 25 shown in FIGS. 6 and 7.

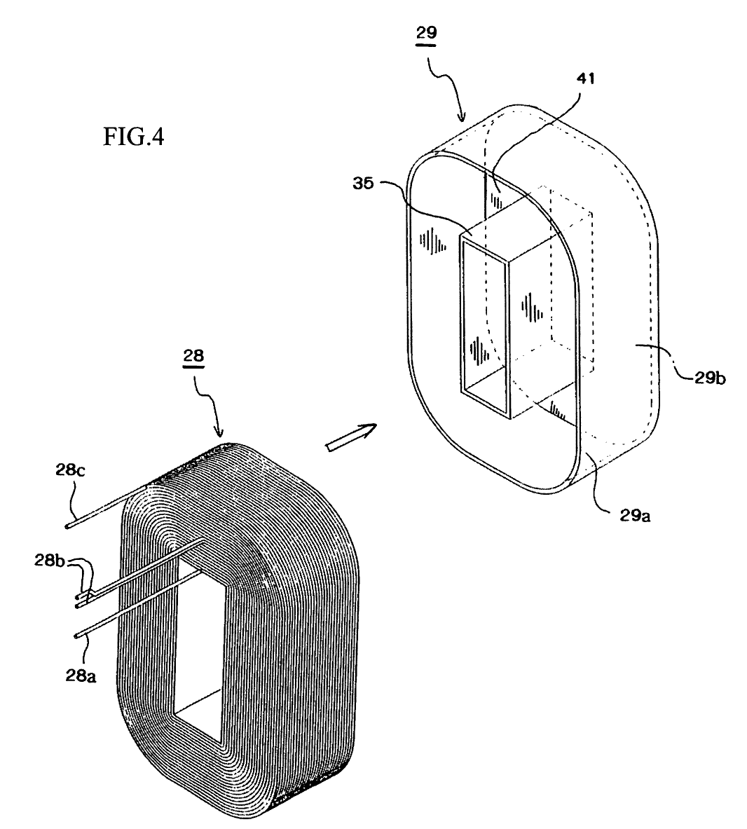

In FIG. 4, the coiled wire 28 that is wound in advance in the shape of a coil is fitted into a channel portion 41 of the bobbin 29. The channel portion 41 is U-shaped in cross section where an erected wall 29a that surrounds a cylindrical winding center portion 35 is integrally formed via a bridging portion 29b. The bobbin 29 is formed of an insulating resin material that insulates the coiled wire 28 and the stator core and the stator core 26 is attached to the winding center portion 35 from both sides in the axial direction. The magnetic pole fragments 30a, 30b are inserted from both sides of the winding center portion 35 by placing the taper portions 31c, 31d in sliding contact and are fitted together until the front end portions thereof abut (see FIG. 1B). The coiled wire 28, where an A coil and a B coil are wound in series, for example, is fitted on the cylindrical winding center portion 35 of the bobbin 29. In FIG. 4, reference numeral 28a designates the winding start, 28b center taps, and 28c a winding end. The coiled wire 28 is formed by winding the wire in a coil on a winding jig, not shown, in advance using an automated machine. The coiled wire 28 is fitted into the channel portion 41 formed around the winding center portion 35 of the bobbin 29. As one example, self-bonding wire (magnet wire) is favorably used as the coiled wire. Self-bonding wire is formed in a coil by heating the wire in a state where the wire has been wound in a coil in advance around a winding jig or by winding the self-bonding wire in a coil while dampening the wire in alcohol to dissolve the bonding agent. The coiled wire 28 formed in this way is fitted onto the winding center portion 35 of the bobbin 29 so as to be enclosed in the channel portion 41 and is bonded to the channel portion 41.

Since the coiled wire 28 that is wound in a coil in advance is fitted into the channel portion 41 formed around the winding center portion 35, the coiled wire 28 can be formed without being affected by deformation, such as bending, of the bobbin 29. Accordingly, since it is easy to properly align the turns of the coiled wire, the winding density can be raised and therefore the efficiency of the motor can be improved.

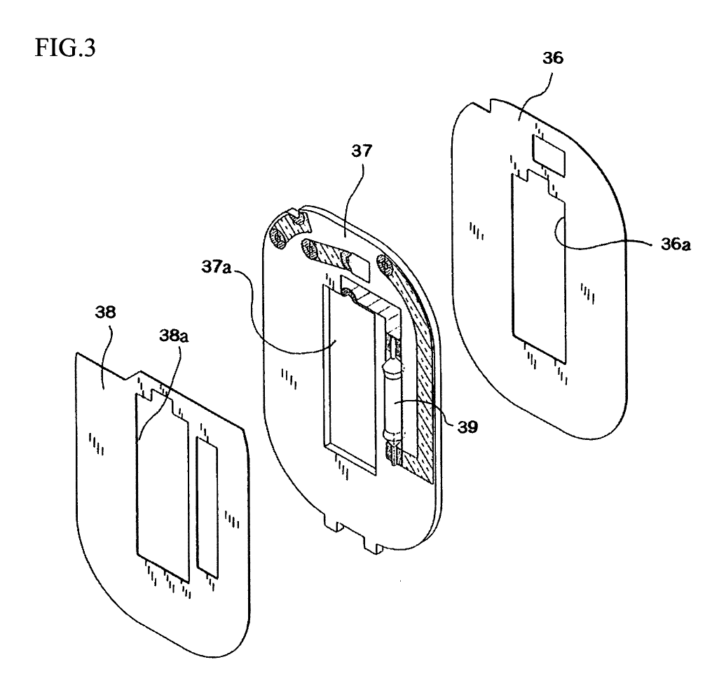

In FIG. 4, the winding center portion 35 of the bobbin 29 is formed so as to protrude further to the outside than the erected wall 29a. The connecting substrate 37 that covers the coiled wires 28, on which a wiring pattern that connects the terminals of the coiled wires 28 together is formed, and which is covered on both sides by insulating films 36, 38 is fitted onto the winding center portion 35. In FIG. 3, the connecting substrate 37 is fitted onto the winding center portion 35 with both sides of the connecting substrate 37 in which a fitting hole 37a is formed covered with the insulating film 36 in which a fitting hole 36a is formed and the insulating film 38 on which a fitting hole 38a is formed. These components are assembled so as to be sandwiched between the stator core 26 and the erected wall 29a by fitting the magnetic pole fragment 30a, for example, into the winding center portion 35 of the bobbin 29 (see FIG. 1B). Also, an external connecting wire 40a for connecting to the winding start 28a of the coiled wire 28 via the thermal fuse 39, an external connecting wire 40b for connecting to the center taps 28b, and an external connecting wire 40c for connecting the winding end 28c are respectively connected to the connecting substrate 37 (see FIG. 2C).

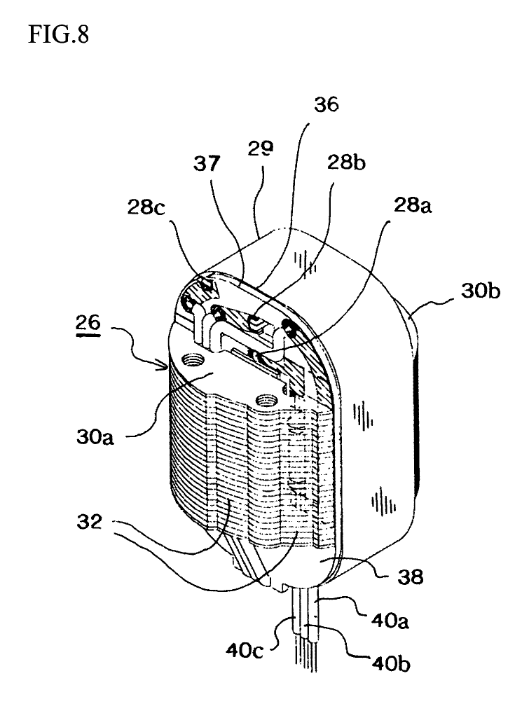

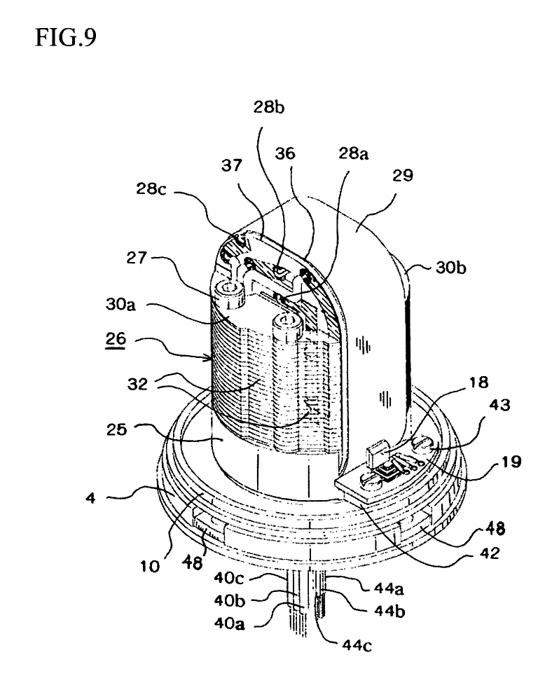

In FIG. 8, the external connecting wires 40a, 40b, and 40c are laid out in the axis direction inside the housing 6 via the concave portions 34 formed in the contact surface portions 33a of the magnetic pole fragment 30a. The wires are led out of the lower housing 4 via the wire leading hole 23 of the wire leading portion 21 fitted into the stator frame 16 (see FIG. 1A). Also, in FIG. 9, the sensor substrate 19, on which the Hall element 18 is mounted is fixed to a substrate fixing portion 42 of the stator frame 16 by the fastening screws 43. The sensor lead wires 44a, 44b, and 44c connected to the sensor substrate 19 are led out of the lower housing 4 via the sensor wire leading hole 24 of the wire leading portion 21 (see FIGS. 2A and 7). Also, since it is possible to lay out the external connecting wires 40a, 40b, and 40c in the axial direction using the concave portions 34 formed in parts of the stator core 26, the wire lengths can be shortened, thereby eliminating the risk of interference with the rotor 1.

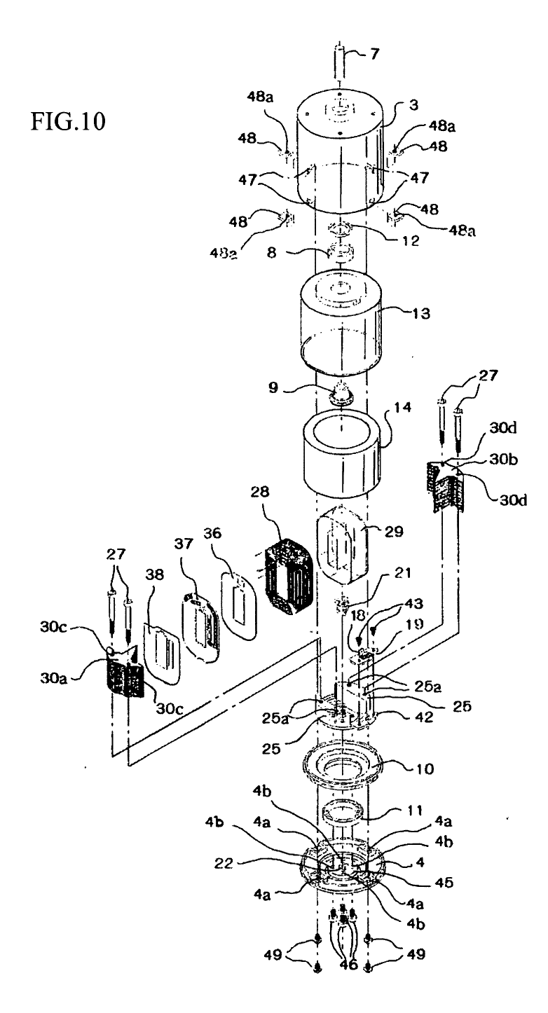

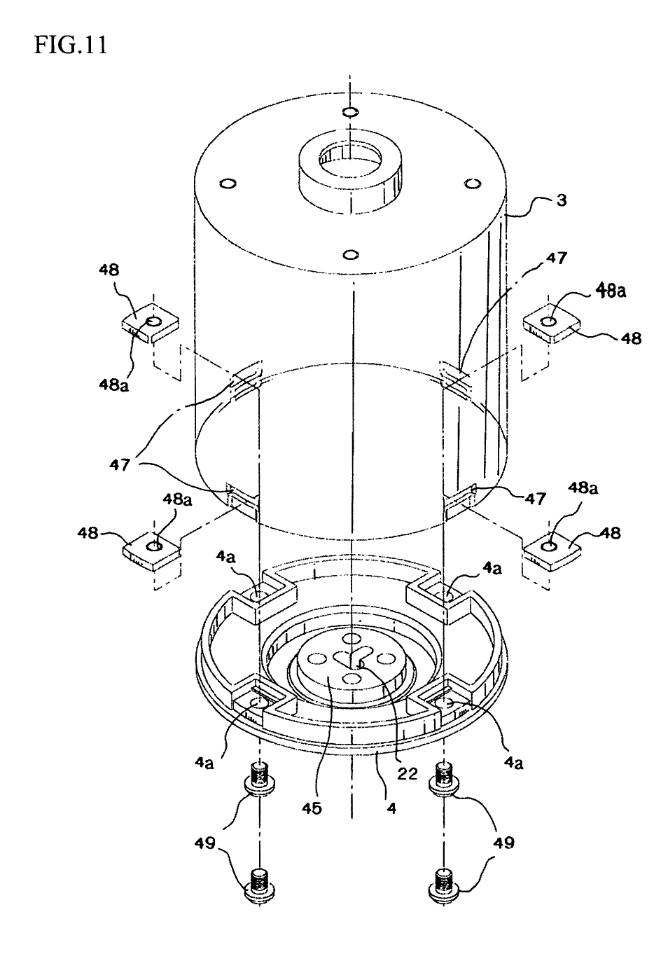

The assembly process for a two-pole synchronous motor will now be described with reference to FIGS. 10 and 11.

First, one example of the assembly process of the rotor 1 will be described with reference to FIG. 10. The boss portion 9 is fitted into a central portion of the rotor case 13 and the cylindrical permanent magnet 14 is fitted into and attached to the inner circumferential surface. Also, the output shaft 7 is integrally fitted into the boss portion 9. The upper bearing 8 is fitted via the preloaded spring 12 into a central portion of the upper housing 3, and inside the rotator case 13, the boss portion 9 is rotatably supported by the upper bearing 8. Also, the rotor bearing member 10, described later, is integrally fitted into a lower end opening of the rotor case 13. The rotor bearing member 10 is rotatably supported by the lower bearing 11 fitted into the lower housing 4.

Next, one example of the assembly process for the stator 2 will be described using FIG. 10. The lower bearing 11 is fitted into the lower housing 4 and the rotor bearing member 10 is supported on the lower bearing 11. In this state, the stator frame 16 is placed on the stator fixing portion 45 provided in the central part of the lower housing 4 and fastening screws 46 are fitted in through the through-holes 4b and screwed to the screw holes 16b at four positions (see FIG. 6B). The wire leading portion 21 is fitted into the fitting hole 22 provided in the stator frame 16 and the stator fixing portion 45, and the sensor substrate 19 on which the Hall element 18 is mounted is screwed to the substrate fixing portion 42 by the fastening screws 43.

The coiled wire 28 that has been wound into a coil using self bonding wire is fitted around and attached to the winding center portion 35, and the insulating film 36, the connecting substrate 37, and the insulating film 38 are placed on top of one another and the winding center portion 35 is passed therethrough so as to cover the coiled wire 28. Next, the magnetic pole fragments 30a, 30b that construct the stator core 26 are inserted from both sides of the bobbin 29 until the front end portions abut one another in the axial direction from both sides of the winding center portion 35 to assemble the connecting substrate 37 laminated between the insulating films 36, 38 on the bobbin 29. The stator core 26 is mounted on the stator mounting portion 25 of the stator frame 16, and the fixing bolts 27 are respectively inserted into the through-holes 30c, 30d of the magnetic pole fragments 30a, 30b, and fixed by being screwed into the screw holes 25a.

In FIG. 11, after the upper housing 3 that houses the rotor case 13 is fitted into the lower housing 4 to house the stator 2 inside the housing 6, insertion hooks 48 in which screw holes 48a are bored are inserted via slit holes 47 provided in a lower end circumferential surface portion of the upper housing 3, and the fastening screws 49 inserted via the through holes 4a of the lower housing 4 are screwed into the screw holes 48a of the insertion hooks 48 to pull together and integrate the upper housing 3 and the lower housing 4 via the insertion hooks 48.

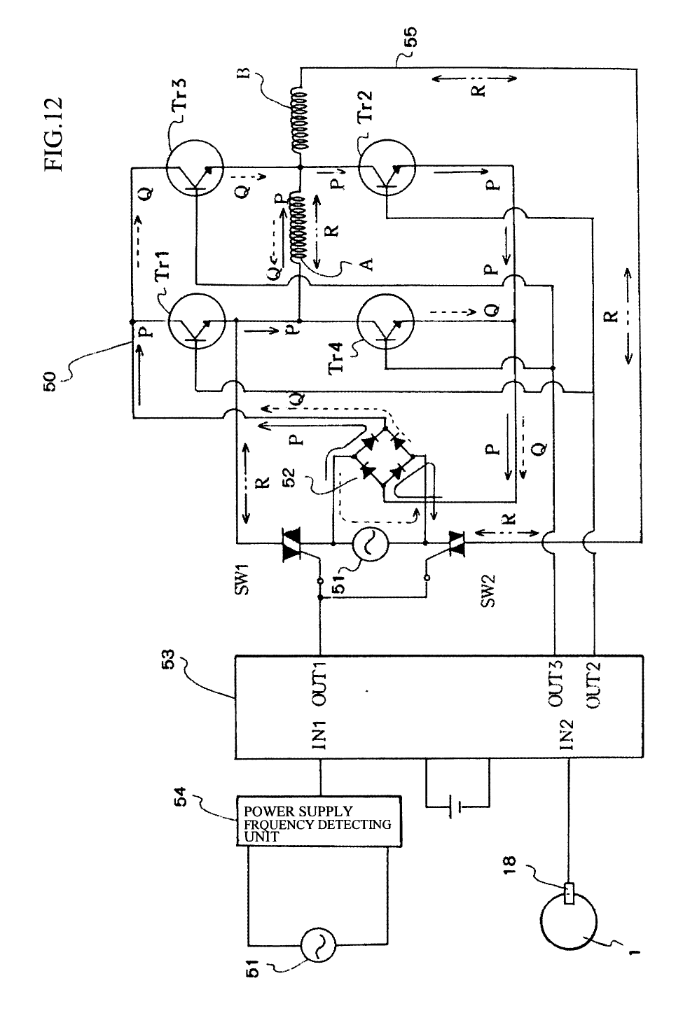

Next, one example of a driving circuit for a two-pole synchronous motor will be described with reference to FIG. 12. A starter circuit 50 carries out full-wave rectification of an AC current of a single-phase AC power supply 51 using a rectifying bridge circuit 52, and an output (OUT2, 3) from a driving circuit control unit (a microcomputer or the like) 53 switches a switching means (transistors Tr1 to Tr4) in accordance with the angle of rotation of the rotor 1 to change the direction (see the arrows PQ in FIG. 12) of the rectified current flowing in the A coil and start the rotor 1 as a DC brushless motor. Alternatively, although not shown, by carrying out switching control in a range that inverts the rectified current flowing alternately in the A coil and B coil, the rotor may be started by suppressing the input at the inverted side with respect to the non-inverted side. It should be noted that during starting, the driving switching switches SW1, SW2 are off.

By controlling the current using the driving circuit control unit 53 in this way, the current direction of the rectified current that flows through only the A coil of the starter circuit 50 is alternately switched to start the motor. Next, when the rotational speed (rpm) of the rotor 1 approaches a rotational speed that is synchronized with a power supply frequency (IN1) inputted from a power supply frequency detecting unit 54 based on an input (IN2) of the detection signal from the Hall element 18, the driving circuit control unit 53 switches the driving switching switches SW1, SW2 via an output (OUT1) from the driving circuit control unit 53 to switch to a synchronous driving circuit 55 and thereby control a transition to synchronous driving by the A coil and B coil (see arrow R in FIG. 12).

Also, if the synchronous motor loses synchronization due to fluctuations in the load or the like, the driving circuit control unit 53 carries out repetitive control for a transition to a starting operation after the rotational speed of the rotor 1 has first fallen to a predetermined value following the transition to synchronous rotation and then carries out a transition back to synchronous driving.

Also, since the two-pole synchronous motor according to the present embodiment is controlled by the driving circuit control unit 53 to carry out a transition from a starting operation to synchronous driving, even if the power supply frequency changes to 50 Hz, 60 Hz, or 100 Hz, for example, it is possible to use the same two-pole synchronous motor without changing the detailed mechanical design, and therefore it is possible to provide a synchronous motor with extremely wide-purpose applicability.

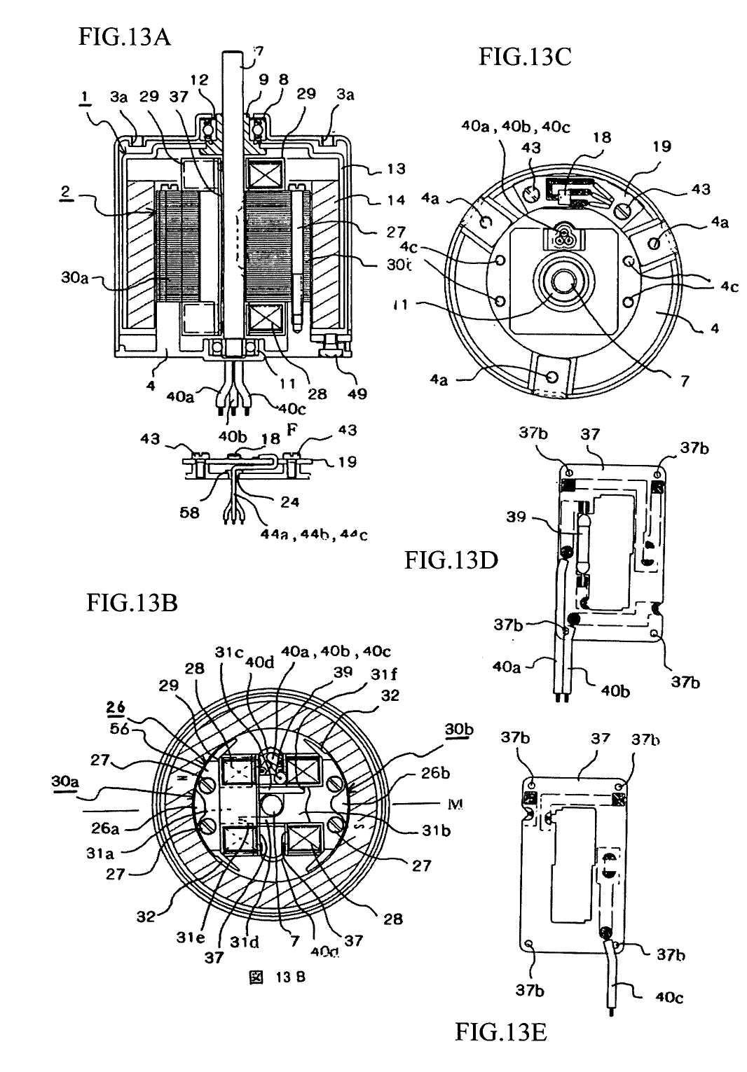

Next, a two-pole synchronous motor according to a second construction will be described with reference to FIGS. 13 to 18. Components that are the same as in the two-pole synchronous motor according to the first construction are designated by the same reference numerals and are covered by the preceding description, with the following description focusing on the differences with the first construction.

In FIG. 13A, the output shaft 7 of the rotor 1 is rotatably supported by the upper housing 3 and the lower housing 4. In the present embodiment, the output shaft 7 is provided so as to pass through the stator 2, with the boss portion 9 fitted onto one end of the output shaft 7 being rotatably supported by the upper bearing 8 and the other end of the output shaft 7 being rotatably supported by the lower bearing 11. Although an upper housing 3 end of the output shaft 7 protrudes out of the housing, the lower housing 4 end may protrude outward, or the output shaft 7 may protrude outward on both sides.

The construction of the stator 2 is as follows. In FIG. 13B, the stator core 26 is dividably assembled with the bobbins 29 on both sides in the axial direction of the bobbins 29, around which the coiled wires 28 are wound. Connecting substrates 37 that connect the coiled wires 29 together are disposed on opposing surfaces of the bobbins 29. The stator core 26 is fixed by screwing in the fixing bolts 27 into the stator fixing portion formed on the lower housing 4.

In FIG. 13B, the stator core 26 is constructed so as to be dividable into the magnetic pole fragment 30a and the magnetic pole fragment 30b. Although the magnetic pole fragments 30a, 30b can have freely chosen shapes, in view of the ease of manufacturing, shapes that have point symmetry about the center of rotation of the rotor 1 are preferable. The insertion portions 31a, 31b of the magnetic pole fragments 30a, 30b are inserted from both sides into the axis hole of the winding center portions 35 of the respective bobbins 29. At the front ends of the insertion portions 31a, 31b, abutting convex portions 31c, 31d and abutting concave portions 31e, 31f are respectively formed. The abutting convex portion 31c of the insertion portion 31a abuts the abutting concave portion 31f of the insertion portion 31b, the abutting convex portion 31d of the insertion portion 31b abuts the abutting concave portion 31e of the insertion portion 31a, thereby integrally assembling the stator core 26 and the bobbins 29. A linking plate 56 is laminated on an upper surface of the stator core 26 and the stator core 26 is fixed to the lower housing 4 by the fixing bolts 27.

Also, the output shaft 7 is provided by being inserted through a gap formed in the front end surfaces of insertion portions 31a, 31b of the magnetic pole fragments 30a, 30b that abut one another. The stator core 26 has a shape that differs on both sides of a central axis M in the long-side direction of the stator core 26 so as to be magnetically asymmetrical about the central axis M. That is, in FIG. 13B, concave portions 32 are respectively provided on parts of the magnetic pole acting surface portions 26a, 26b of the magnetic pole fragments 30a, 30b to form gaps (voids) where the distance between the permanent magnet 14 on the rotor and the magnetic pole portions is increased. The concave portions 32 are formed at positions (positions rotated by 180°) that have point symmetry about the center of rotation of the rotor 1. Due to the concave portions 32, the magnetic flux that acts from the magnetic pole acting surface portions 26a, 26b is unbalanced on the left-right sides of the central axis M and is biased in one direction, that is, the magnetic flux acts on the magnetic pole acting surface portions 26a, 26b so as to be biased in the clockwise direction where the magnetic resistance is low (where the gaps are smaller).

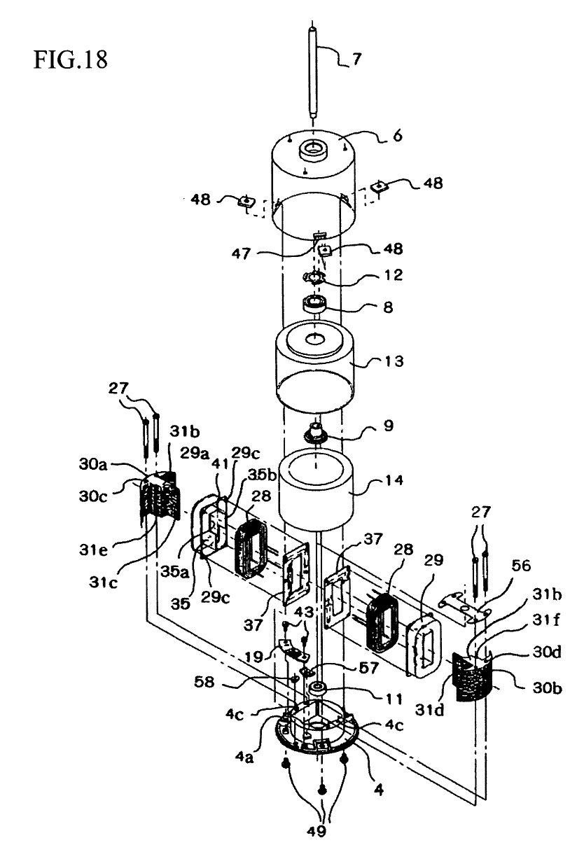

Also, although the bobbins 29 that are assembled together with the magnetic pole fragments 30a, 30b may be the same as the bobbin 29 shown in FIG. 4, in the present embodiment, concave parts 35a and convex parts 35b are respectively formed in opposite end surfaces of the winding center portions 35 and when the bobbins 29 are assembled together with the magnetic pole fragments 30a, 30b, the facing concave parts 35a and convex parts 35b are fitted together to position the bobbins 29 (see FIG. 18). Each coiled wire 28 that is wound in advance in the shape of a coil is fitted into a channel portion 41 of one of the bobbins 29 that are U-shaped in cross section where the erected wall 29a that surrounds the cylindrical winding center portion 35 is integrally formed via the bridging portion 29b. Since the coiled wires 28 that are wound in coils in advance are fitted into the channel portions 41 formed around the winding center portions 35, the coiled wires 28 can be formed without being affected by deformation, such as bending, of the bobbins 29.

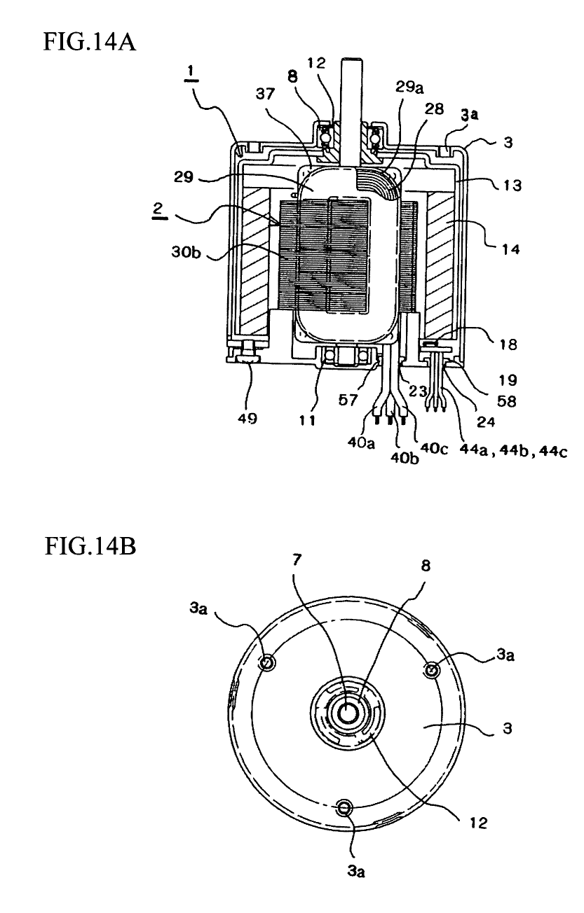

By positioning fitting holes 37b of the connecting substrates 37 shown in FIGS. 13D and 13E on protrusions 29c (see FIG. 18) provided at four positions on end surfaces (opposing surfaces of the bobbins 29) of the erected walls 29a that construct the channel portions 41 of the bobbins 29 and fitting and thermally welding such parts, the bobbins 29 and the connecting substrates 37 are integrated. The external connecting wires 40a, 40b, and 40c, the thermal fuse 39 provided on part of the substrate wiring in FIG. 13D, and a substrate-connecting wire 40d (see FIG. 13B) are provided in the gap formed between the connecting substrates 37. The external connecting wires 40a, 40b, and 40c are disposed immediately below in the axial direction and are led out of the housing through the wire leading hole 23 (see FIG. 14A) provided in the lower housing 4.

Also, in FIG. 13C, screw holes 4c in which the fixing bolts 27 that are fitted through the stator core 26 are screwed are provided in a part of the lower housing 4 on which the stator core 26 is mounted. Also, the sensor substrate 19 is fixed to the lower housing 4 by the fastening screws 43. In FIGS. 13F and 14A, the Hall element 18 is mounted on the sensor substrate 19 and the sensor lead wires 44a, 44b, and 44c connected to the sensor substrate 19 are led out of the housing via the sensor wire leading hole 24 provided directly below the substrate.

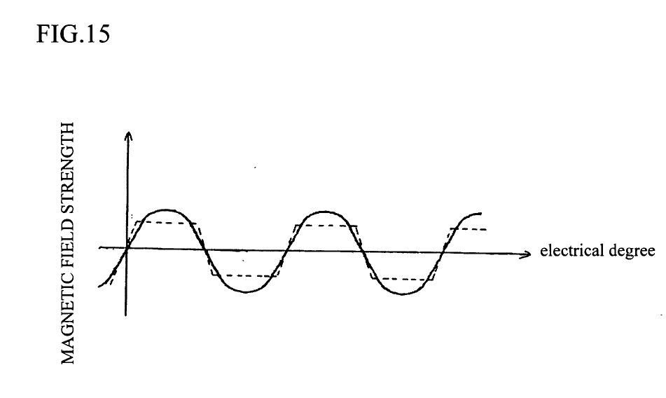

Also, the inner circumferential surface of the rotor 1 that faces the stator magnetic poles of the permanent magnet 14 is sinusoidally magnetized as shown by the solid line in FIG. 15. The end surface in the axial direction that is the magnetic pole detection surface is trapezoidally magnetized as shown by the broken line in FIG. 15. When leaking magnetic flux from the permanent magnet 14 is picked up by the Hall element 18 to detect the magnetic pole positions, although the magnetic pole switching positions (zero cross points) can be difficult to determine with sinusoidal magnetization depending on the sensitivity of the sensor, with trapezoidal magnetization (or quasi-sinusoidal magnetization), the magnetic pole switching positions can be accurately detected and the current direction is switched, and therefore a starting operation of the rotor 1 is stabilized.

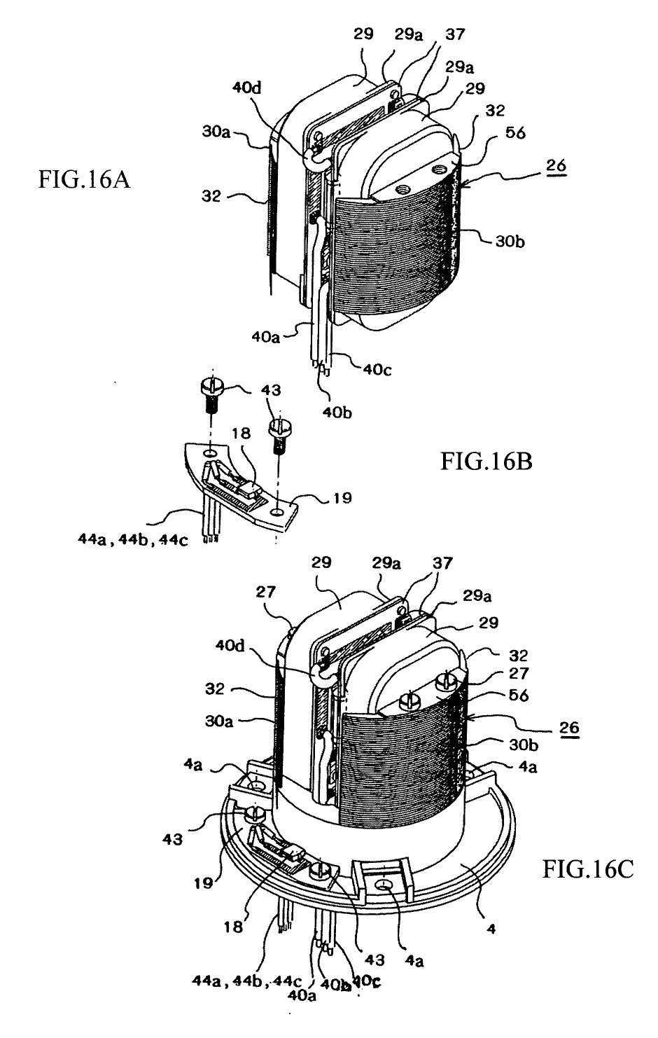

Next, one example of the assembly process of the two-pole synchronous motor according to the second construction will be described with reference to FIGS. 16 to 18.

First, one example of the assembly process of the rotor 1 will be described with reference to FIG. 18. The boss portion 9 is fitted into a central portion of the rotor case 13 and is integrated by crimping, and the cylindrical permanent magnet 14 is fitted into and attached to the inner circumferential surface. Also, the output shaft 7 is integrally fitted into the boss portion 9. The upper bearing 8 is fitted via the preloaded spring 12 into a central portion of the upper housing 3 to prevent the rotor 1 from rising in the axial direction. The boss portion 9 of the rotor 1 is rotatably supported by the upper bearing 8 and the output shaft 7 of the rotor 1 is rotatably supported by the lower bearing 11 provided on the lower housing 4.

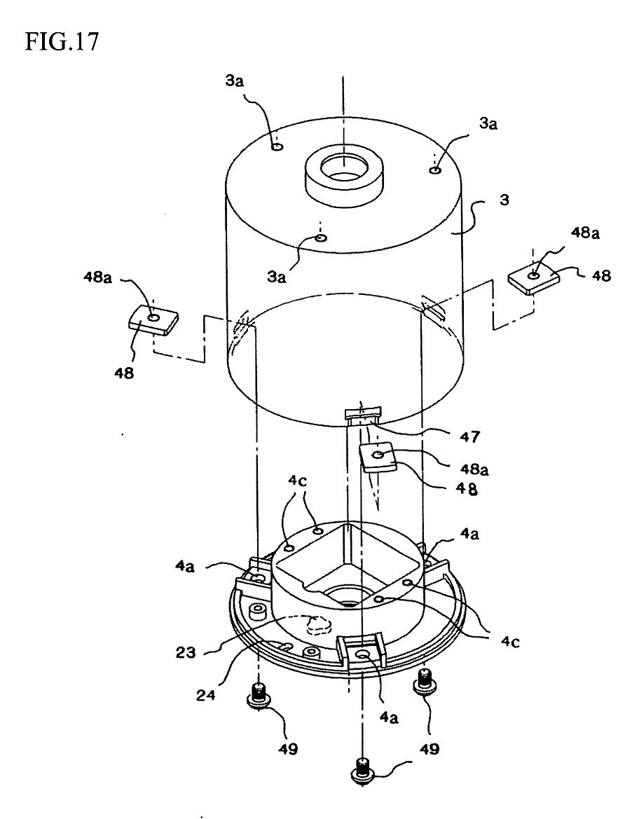

Next, one example of the assembly process for the stator 2 will be described using FIGS. 16 to 18. In FIG. 18, the coiled wires 28 that are wound in coils in advance using self-bonding wire are fitted onto the winding center portions 35 in the channel portions 41 of the respective bobbins 29 and are attached inside the channel portions 41. Next, the connecting substrates 37 are placed over the side surfaces of the erected walls 29a so as to cover the respective coiled wires 28 and welded. After this, the linking plate 56 is erected and inserted from one side out of the left and right bobbins 29 (in FIG. 18, the right side) through the axis hole of the winding center portion 35 on the other side and the coupling plate is then changed to the core laminating direction and placed on the magnetic pole fragments 30a, 30b inserted from both sides of the winding center portions 35 to assemble the stator core 26 (see FIG. 16A). The stator core 26 is mounted on the stator mounting portion of the lower housing 4 and the fixing bolts 27 are respectively inserted into the through-holes 30c, 30d of the magnetic pole fragments 30a, 30b and screwed into and integrally fixed to the screw holes 4c (see FIGS. 16A, 16C). The sensor substrate 19 (see FIG. 16B) on which the Hall element 18 is mounted is also screwed to the lower housing 4 by the fastening screws 43 (see FIGS. 16B, 16C). Also, insulating components (resin members, grommets, and the like) 57, 58 that fit into the lead holes 23, 24 (see FIG. 17) which lead out the external connecting wires 40a, 40b, and 40c and the sensor lead wires 44a, 44b, and 44c are fitted into the lower housing 4.

Finally, in FIG. 18, after the upper housing 3 that houses the rotor case 13 is fitted into the lower housing 4 to house the stator 2 inside the housing 6, the insertion hooks 48 in which the screw holes 48a are bored are inserted via the slit holes 47 provided in the lower end circumferential surface portion of the upper housing 3, and the fastening screws 49 inserted via the through holes 4a of the lower housing 4 are screwed into the screw holes 48a of the insertion hooks 48 to pull together and integrate the upper housing 3 and the lower housing 4 via the insertion hooks 48. Also, motor attachment screw holes 3a are formed at three positions on the upper housing 3 (see FIGS. 14B and 17).

The same circuit as that shown in FIG. 12 is used as the driving circuit of the two-pole synchronous motor of the present embodiment.

In the two-pole synchronous motor of the present embodiment, compared to the bobbin 29 of the first construction, the winding density of the coiled wires 28 is lower, but since the number of turns in the coil is substantially determined in accordance with the torque due to the rotational frequency of the motor, by selecting the wire diameter, it is possible to provide a synchronous motor with favorable performance without a drop in the output efficiency.

It is possible to transmit the motor driving with the output shaft 7 protruding not only from one end but from both ends, and since the same shapes can be used on the left and right sides of components, it is possible to improve productivity and to reduce the length of the wires for externally connecting the coils, and therefore a compact, high-performance motor can be provided cheaply.

The synchronous motor according to the present invention is not limited to the embodiment described above, and it is possible to change the shapes of the magnetic pole fragments 30a, 30b that are formed so as to be magnetically asymmetrical and the shapes, positions, sizes, ranges, and the like of the concave portions 32 formed in the magnetic pole acting surface portions 26a, 26b. Also, the driving circuit control unit 53 that controls the driving of the motor may be integrally provided with the motor, or part (including the AC power supply, starter circuit, synchronous driving circuit, and the like) of a control circuit installed in the main body of an electronic appliance that uses a motor may be used to control the driving of the motor.

Also, to ensure safety for the control circuit including the connecting substrate 37 during an overload, aside from the thermal fuse 39, it is possible to install a bi-metal temperature detecting switch at a circuit part where current always flows during a driving operation. Also, the synchronous motor is not limited to having two poles, and the present invention can be applied in the same way to an outer-rotor type motor with four, six, eight, or another number of poles.

1. A synchronous motor comprising a rotor that is supported inside a housing so as to be rotatable about an output shaft and a stator disposed in a void surrounded by the rotor,
wherein a stator core is assembled so as to be dividable on both sides in an axial direction of a bobbin around which a coiled wire is wound.

2. A synchronous motor according to claim 1, wherein magnetic pole acting surface portions of the stator core that oppose the rotor have different shapes on both sides of a central axis in a long-side direction of the stator core so as to be magnetically asymmetrical about the central axis.

3. A synchronous motor according to claim 1, wherein the coiled wire is wound into a coil in advance using a winding jig and fitted into a channel portion of the bobbin.

4. A synchronous motor according to claim 1, wherein the coiled wire is wound into a coil in advance and fitted into a channel portion of the bobbin, the channel portion being U-shaped in cross section by having an erected wall that surrounds a cylindrical winding center portion integrally formed via a bridging portion, and divided parts of the stator core are inserted into the winding center portion from both sides thereof in the axial direction and fitted together with front end portions thereof abutting.

5. A synchronous motor according to claim 4, wherein the winding center portion is formed so as to protrude further outward than the erected wall, and a connecting substrate, on which a wiring pattern for connecting terminals of the coiled wire together is formed, is covered on both sides by insulating films and fitted onto the winding center portion so as to be sandwiched by the stator core and the erected wall.

6. A synchronous motor comprising a rotor that is supported inside a housing so as to be rotatable about an output shaft and a stator disposed in a void surrounded by the rotor,
wherein a stator core is assembled so as to be dividable on both sides in an axial direction of bobbins around which coiled wires are wound and a connecting substrate for connecting the coiled wires together is disposed at facing surfaces of the bobbins.

7. A synchronous motor according to claim 6, wherein magnetic pole acting surface portions of the stator core that oppose the rotor have different shapes on both sides of a central axis in a long-side direction of the stator core so as to be magnetically asymmetrical about the central axis.

8. A synchronous motor according to claim 6, wherein the coiled wires are wound into coils in advance using a winding jig and fitted into channel portions of the bobbins.

9. A synchronous motor according to claim 6, further comprising a linking plate that links and fixes together divided parts of the stator core that have been assembled from both sides through centers of the bobbins.

10. A synchronous motor according to claim 6, wherein an inner circumferential surface of a rotor magnet that opposes a stator magnet is sinusoidally magnetized and a magnetic pole detection surface is trapezoidally magnetized.
